(19) United States
(12) Patent Application Publication
(10) Pub. No.: US 2016/0083035 A1
(43) Pub. Date: Mar. 24, 2016

(54) METHOD AND DEVICE FOR RELOCATING A MOTORCYCLE PASSENGER FLOORBOARD

(71) Applicant: Greg Edward Eccher, Mount Olive, IL (US)

(72) Inventor: Greg Edward Eccher, Mount Olive, IL (US)

(21) Appl. No.: 14/863,379

(22) Filed: Sep. 23, 2015

Related U.S. Application Data
(60) Provisional application No. 62/054,111, filed on Sep. 23, 2014.

(51) Int. Cl. B62J 25/00

(52) U.S. Cl. CPC B62J 25/00

(57) ABSTRACT

A method embodying a kit assembly for relocating a motorcycle passenger floorboard is provided. The kit assembly may include an extension plate and a base plate, each forming a complementary elongated slot and bolt hole that align when the two plates are in a stacked configuration. The extension plate extends further than the base plate in the stacked configuration, defining an extension portion thereof. A plurality of spaced-apart threaded holes may be formed in the extension portion. In the stacked configuration, the plates may be joined to a motorcycle frame from where a floorboard bracket was dismounted so that the same floorboard bracket may be moved outward and rearward and the remounted to the plurality of spaced-apart threaded holes; thereby, enabling more leg room for riders carrying passengers

### CROSS-REFERENCE TO RELATED APPLICATION

This application claims the benefit of priority of U.S. provisional application No. 62/054,111, filed 23 Sep. 2014, the contents of which are herein incorporated by reference.

### BACKGROUND OF THE INVENTION

The present invention relates to motorcycle equipment and, more particularly, to a method embodying a kit assembly for relocating a motorcycle passenger floorboard.

Typically when a motorcycle has a passenger there is typically a lack of leg room between the rider floorboard and the passenger floorboard of the motorcycle. This lack of leg room may be merely uncomfortable or even dangerous. Without a place for one's feet, the rider and/or passenger may feel cramped. Without the available space to freely move their legs, the rider may have insufficient leg room to place their foot on the ground to hold the motorcycle up when stopped, or such lack of leg room may even cause the rider to lose control when making a stop.

As can be seen, there is a need for a method embodying a kit assembly for relocating a motorcycle floorboard, whereby the original equipment (OEM) or readily available aftermarket parts may be used in the process.

### SUMMARY OF THE INVENTION

In one aspect of the present invention, a motorcycle passenger floorboard relocation kit assembly includes a base plate forming a base elongated slot and a base bolt hole; an extension plate forming an extension elongated slot and an extension bolt hole, wherein the elongated slots and bolt holes align, respectively, when the plates are arranged in a stacked configuration; an extension portion defined by the extension plate; and a plurality of spaced-apart threaded holes formed in the extension portion.

In another aspect of the present invention, a method of relocating a motorcycle passenger floorboard includes dismounting the motorcycle passenger floorboard from a frame portion; joining a stacked configuration of a base plate and an extension plate to the frame portion, wherein the extension plate sandwiches the base plate against the frame portion in the stacked configuration, and wherein the extension plate has an extension portion extending farther along a shared alignment axis than the base plate; and remounting the motorcycle passenger floorboard to the extension portion.

These and other features, aspects and advantages of the present invention will become better understood with reference to the following drawings, description and claims.

### BRIEF DESCRIPTION OF THE DRAWINGS

FIG. 1 is a perspective view of an exemplary embodiment of the present invention, shown in use;

FIG. 2 is a detail perspective view of an exemplary embodiment of the present invention, shown in use;

FIG. 3 is a perspective view of an extension plate an exemplary embodiment of the present invention;

FIG. 4 is a profile view of the extension plate of an exemplary embodiment of the present invention;

FIG. 5 is a perspective view of a base plate of an exemplary embodiment of the present invention;

FIG. 6 is a profile view of the base plate of an exemplary embodiment of the present invention; and

FIG. 7 is an exploded view of an exemplary embodiment of the present invention, shown in use.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a method embodying a kit assembly for relocating a motorcycle passenger floorboard. The kit assembly may include an extension plate and a base plate, each forming a complementary elongated slot and bolt hole that align when the two plates are in a stacked configuration. The extension plate extends further than the base plate in the stacked configuration, defining an extension portion thereof. A plurality of spaced-apart threaded holes may be formed in the extension portion. In the stacked configuration, the plates may be joined to a motorcycle frame from where a floorboard bracket was dismounted so that the same floorboard bracket may be moved outward and rearward and then remounted to the plurality of spaced-apart threaded holes; thereby, enabling more leg room for riders carrying passengers.

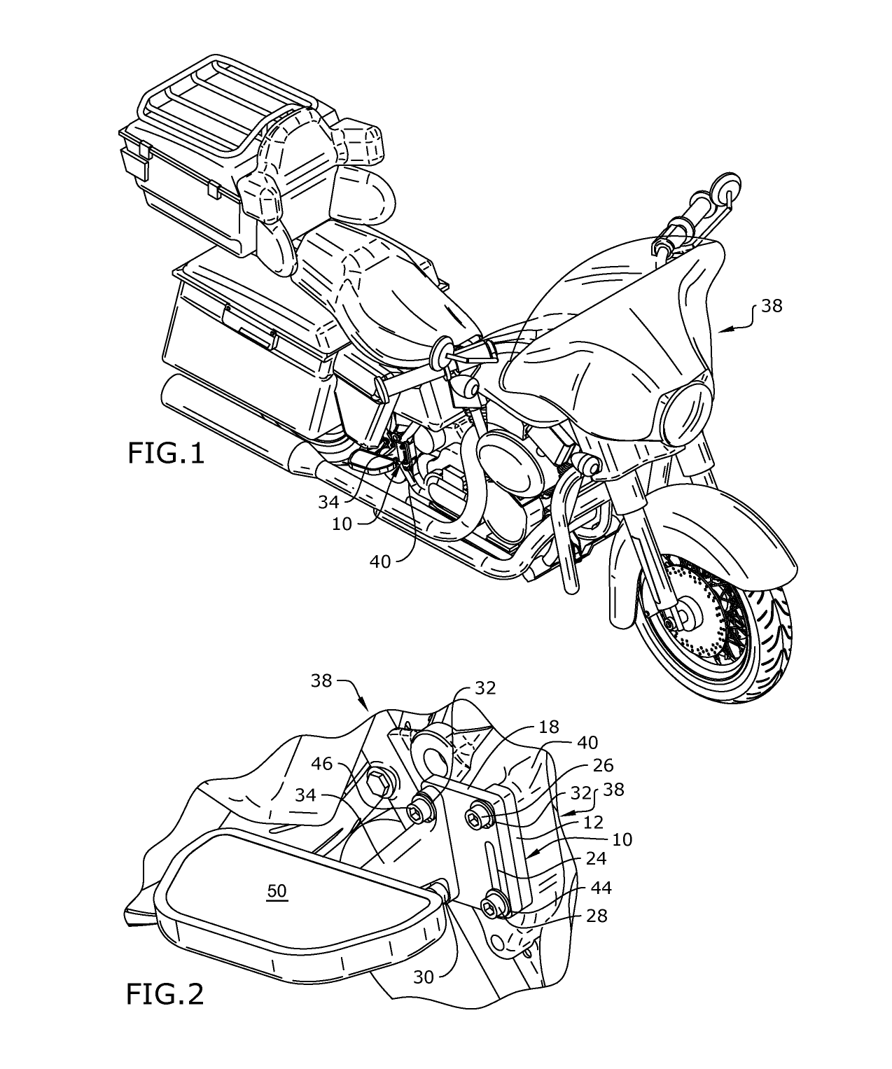

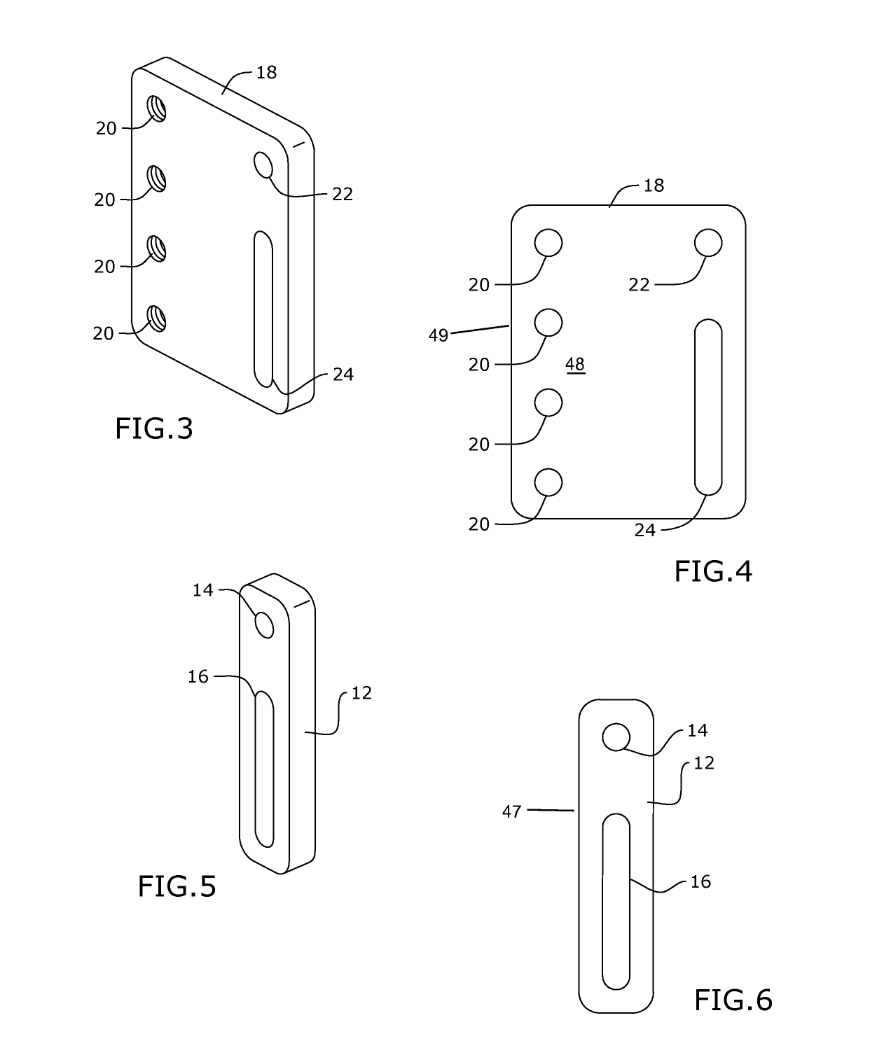

As is illustrated in FIGS. 1 through 7, the present invention may include a method embodying a kit assembly 10 for relocating a passenger floorboard 50 for a motorcycle 38. The kit assembly 10 may include an extension plate 18 and a separate base plate 12. The plates 18, 12 may be made from durable, resilient material, such as steel, aluminum or any other like material, via a milling machine, a water jet machine or the like.

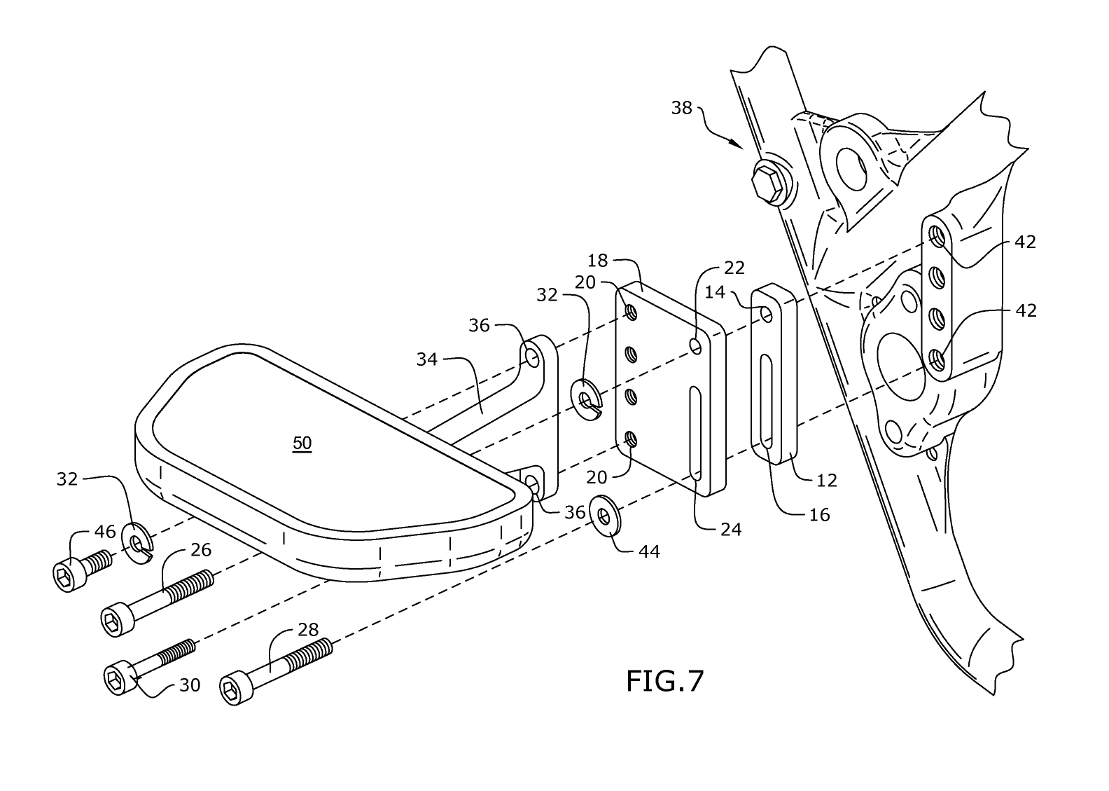

The extension plate 18 may form an extension elongated slot 24 and an adjacent extension bolt hole 22. The base plate 12 may form a base elongated slot 16 and an adjacent base bolt hole 14. The elongated slots 24, 16 and adjacent bolt holes 22, 14 may be dimensioned and adapted so that the complementary elongated slots 24, 16 align and the complementary bolt holes 22, 14 align when the plates 18, 12 are in a stacked configuration, as illustrated in FIGS. 2 and 7.

In the stacked configuration, a distance from the elongated slot 24 to a distal edge 49 of the extension plate 18 is greater than a distance from the elongated slot 16 to a distal edge 47 of the base plate 12, wherein an extension portion 48 is defined by the excessive distance of the extension plate 18, as illustrated in FIG. 4. The extension portion 48 may form a plurality of spaced apart threaded fastener holes 20. Each threaded fastener hole 20 may include threading therein for securing fasteners thereto.

A method of using the present invention may include the following. The kit assembly 10 disclosed above may be provided. A user may remove the passenger floorboard 50 from the motorcycle 38 by dismounting the floorboard bracket 34 from a frame portion 40. This is typically accomplished by removing the fasteners that secures through the two bracket holes 36 of the floorboard bracket 34 and into two of a plurality of frame holes 42 formed in the frame portion 40. Then the user may arrange the plates 18, 12 in the stacked configuration so that the bolt holes 22, 14 align with one of the plurality of frame holes 42 and the elongated slots 24, 16 align with at least one frame holes 42. The elongated slots enable tolerance when aligning elongated slots 24, 16 with frame holes 42 and thus the ability to choose an optimal one from the plurality.

Then the user may join the stacked configuration to the frame portion 40 by using a first fastener 26 and a lock washer 32 for the bolt holes 22, 14 and a second fastener 28 and a flat washer 44 for the elongated slots 24, 16. The user may then remount the floorboard bracket 34 to the extension portion 48 by interconnecting two bracket holes 36 to two threaded fastener holes 20 via a third fastener 30 and a fourth fastener 46, respectively. The fourth fastener 46 may include a lock washer 32, too. As a result, the passenger floorboard 50 is relocated outward from the frame portion 40 and rearward toward the would-be passenger, allowing for the rider of the motorcycle 38 to have more leg room when putting his or her feet down to hold the motorcycle up or just enjoy the ride.

Because of the varying lengths that the different fasteners may need to traverse to be properly secured, as illustrated in FIG. 7, the first fastener 26 may be a ⅜″-16×2″ bolt, while the second fastener 28 may be a 5/16″-18×2″ bolt, the third fastener 30 a ⅜″-16×⅞″ bolt, and the fourth fastener a ⅜″-16×1″ bolt. The fourth fastener 46 may be original equipment (OEM), i.e., the fastener used prior to the relocation of the passenger floorboard 50. This way the OEM and other readily available aftermarket parts may be used as part of the present invention so as to facilitate its use, maintenance and repair.

It should be understood, of course, that the foregoing relates to exemplary embodiments of the invention and that modifications may be made without departing from the spirit and scope of the invention as set forth in the following claims.

What is claimed is:

1. A motorcycle passenger floorboard relocation kit assembly, comprising:
a base plate forming a base elongated slot and a base bolt hole;
an extension plate forming an extension elongated slot and an extension bolt hole, wherein the elongated slots and bolt holes align, respectively, when the plates are arranged in a stacked configuration;
an extension portion defined by the extension plate; and
a plurality of spaced-apart threaded holes formed in the extension portion.

2. The motorcycle passenger floorboard relocation kit assembly of claim 1, further comprising: a first fastener; a second fastener; a third fastener; and a fourth fastener.

3. The motorcycle passenger floorboard relocation kit assembly of claim 2, wherein the first fastener, the second fastener, the third fastener, and the fourth fastener are different sized bolts.

4. The motorcycle passenger floorboard relocation kit assembly of claim 2, wherein the first fastener is a ⅜″-16×2″ bolt; the second fastener is a 5/16″-18×2″ bolt; the third fastener is a ⅜″-16×2″ bolt; and the fourth fastener is a ⅜″-16×1″ bolt.

5. The motorcycle passenger floorboard relocation kit assembly of claim 2, further comprising a lock washer associated with each of the first and fourth fasteners; and a flat washer associated with the second fastener.

6. The motorcycle passenger floorboard relocation kit assembly of claim 1, wherein the extension portion is defined by a difference in a distance between the elongated slots and of a distal edge of each of the base and extension plates, respectively.

7. A method of relocating a motorcycle passenger floorboard, comprising the steps of:
dismounting the motorcycle passenger floorboard from a frame portion;
joining a stacked configuration of a base plate and an extension plate to the frame portion, wherein the extension plate sandwiches the base plate against the frame portion in the stacked configuration, and wherein the extension plate has an extension portion extending farther along a shared alignment axis than the base plate; and
remounting the motorcycle passenger floorboard to the extension portion.

8. The method of claim 7, wherein each of the base and extension plates having a elongated slot and a bolt hole that align, respectively, in the stacked position.

9. The method of claim 7, wherein fasteners used in the dismounting are used in the remounting.
